(19) United States
(12) Patent Application Publication
(10) Pub. No.: US 2022/0181690 A1
(43) Pub. Date: Jun. 9, 2022

(54) ELECTROLYTE ADDITIVE, NON-AQUEOUS ELECTROLYTE, AND LITHIUM ION BATTERY USING SAME

(71) Applicant: Zhuhai Smoothway Electronic Materials Co., Ltd., Zhuhai (CN)

(72) Inventors: Chong Mao, Zhuhai (CN); Jing Bai, Zhuhai (CN); Pipi Wang, Zhuhai (CN); Qiujie Huang, Zhuhai (CN); Shuanghui Ou, Zhuhai (CN); Yuanwei Zhou, Zhuhai (CN); Xiaobing Dai, Zhuhai (CN)

(21) Appl. No.: 17/190,579

(22) Filed: Mar. 3, 2021

(30) Foreign Application Priority Data
Dec. 7, 2020 (CN) 202011419865.3

(51) Int. Cl. H01M 10/0567; H01M 10/0525; H01M 4/525

(52) U.S. Cl. CPC H01M 10/0567; H01M 2004/028; H01M 4/525; H01M 10/0525

(57) ABSTRACT

The present invention relates to an electrolyte additive, a non-aqueous electrolyte and a lithium ion battery using same. The electrolyte additive includes a compound represented by Formula 1:

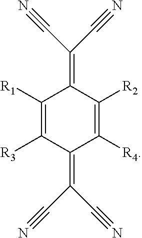

In Formula 1, R₁, R₂, R₃, and R₄ are each independently hydrogen atom, halogen atom, a substituted or unsubstituted chain C₁-C₁₂ alkyl group, a substituted or unsubstituted chain C₂-C₁₂ alkenyl group, a substituted or unsubstituted chain C₂-C₁₂ alkynyl group, or groups represented by RCₙH₂ₙ₊₁. R is each independently oxygen atom or sulfur atom, and n is positive integer. The electrolyte additive has a special structure. During the first charge and discharge process, redox products formed by oxidation-reduction reaction of multiple conjugated olefin structures adhere to the positive and negative electrode surfaces to form solid electrolyte interface films. The films have low impedance and high lithium ion conductivity, so the lithium ion battery has excellent rate performance and low temperature performance.

### RELATED APPLICATIONS

This application claims the benefit of priority to Chinese Patent Application No. 202011419865.3 filed in Dec. 7, 2020, which is hereby incorporated by reference in its entirety.

### FIELD OF THE INVENTION

The invention relates to the field of secondary battery, in particular to an electrolyte additive, a non-aqueous electrolyte and a lithium ion battery using same.

### BACKGROUND OF THE INVENTION

Due to high specific energy, no memory effect and good cycling life, lithium ion batteries are widely used in Computer-Communication-Consumer Electronics digital products (3C), power tools, aerospace, energy storage, power vehicles and other fields. With the rapid development of electronic information technology and consumer products, there is an urgent demand for lithium ion batteries with higher volume&weight energy density and faster charging rate. Improving the charging voltage is the most effective way to increase the single cell energy density. Consequently, domestic and foreign manufacturers of batteries have worked on high-voltage lithium ion batteries.

Currently, high-voltage lithium cobalt oxide (LCO) is still the mainstream cathode material for 3C lithium battery and the output of LCO has been steadily increased in recent years. With the industrialization of high voltage (≥4.5V) LCO, the technical level of LCO has been raised to a whole new level. Correspondingly, the specific capacity of LCO has been increased from common 140 mAh/g (4.2V) to 220 mAh/g (4.6V). Therefore, the battery will have a larger discharging capacity and be positive to upgrade the communication technology from 4G to 5G or even 6G. At present, modified 4.35V, 4.4V and 4.45V LCO batteries and its electrolytes have been industrialized. However, there are still a series of challenges in 4.5V and even higher voltage LCO battery technology.

Actually, the theoretical specific capacity of Li₁₋ₓCoO₂ can be as high as 274 mAh/g. Typically, when x is more than 0.4, the theoretical cut off voltage should be greater than 4.45 V. However, when LC(O is charged to such a high voltage, it undergoes a harmful phase transition from O₃ hexagonal phase to the hybridized O₁-O₃ hexagonal phase, which accompanies by sliding of the lattice layers and partial collapse of the O₃ lattice structure. Subsequently, the internal strain of LCO increases, which causes the crack formation and particle pulverization. In addition, the oxygen redox begins to occur at high voltages since the top of the O²⁻: 2p resonant band is overlapped with the low-spin Co^{3+/4+}: t_{2g} resonant band. As peroxide ion O₁₋ has a higher ion mobility than O²⁻, O¹⁻ near the surface would become to O₂ and easily leaves LCO particles, which breaks the cathode-electrolyte interface and thus causes the interfacial instability and poor cycle performance of LCO batteries. Therefore, to obtain a stable cycling performance, the cut-off voltage of LCO is usually lower than 4.45 V with a limited capacity of 175 mAh/g.

There are many strategies to improve the stability of cathode and further improve the electrochemical performance of high voltage LCO battery, for example bulk doping transition elements, surface coating, single crystallization, or adding electrolyte additives. Compared with other methods, adding functional electrolyte additives is most effective and fits for industrialization.

At present, there have been some reports on additives for high-voltage LCO battery systems, and these additives usually have a nitrile group. Because nitrile compounds can form coordination bonds with metal ions, which reduces dissolution of transition metals in the positive electrode and prevents transition metal ions from depositing on the negative electrode and blocking the negative electrode pores, thereby improving thermal shock performance of the batteries. As reported in U.S. Pat. No. 9,819,057, rechargeable lithium batteries containing nitrile compounds have good thermal shock performance and endurance. Patent US20200243907A1 reports that there is a synergistic effect between cesium salt and a nitrile compound with a specific structure, which can improve the floating and fast charging performance of lithium batteries. Because cesium salt is combined with nitrile compound additives with a specific structure, a thin and uniform SEI film will be formed during the first charge and discharge of the lithium battery, and the SEI film has higher lithium ion conductivity. According to the patent CN110429335A, the electrolyte contains a benzoquinone compounds containing the nitrile group, which is not easy to be oxidized and can also chelate with active ions. Therefore, the electrolyte can form SEI film with lower impedance and higher stability on the positive and negative electrodes, and inhibit side reactions on the positive and negative electrodes. However, the above-mentioned additives containing a nitrile group decompose rapidly at the interface of 4.5V LCO during charge-discharge process, resulting in increasing the internal resistance of the battery, which affects the cycle performance of the lithium battery. Furthermore, the solid electrolyte interface (SEI) formed by such nitrile additives has a poor conductivity, which goes against the rate capability and low temperature performance.

### SUMMARY OF THE INVENTION

One objective of the present invention is to provide an electrolyte additive, a non-aqueous electrolyte and a lithium ion battery using same. The electrolyte can be suitable for lithium ion batteries under high voltage and improve the cycle performance, high and low temperature performance and rate performance of the battery.

To achieve the above objective, an electrolyte additive including a compound represented by Formula 1 is provided. Specifically, in Formula 1, R₁, R₂, R₃, and R₄ are each independently hydrogen atom, halogen atom, a substituted or unsubstituted chain C₁-C₁₂ alkyl group, a substituted or unsubstituted chain C₂-C₁₂ alkenyl group, a substituted or unsubstituted chain C₂-C₁₂ alkynyl group, or groups represented by RCₙH₂ₙ₊₁, R is each independently oxygen atom or sulfur atom, and n is positive integer.

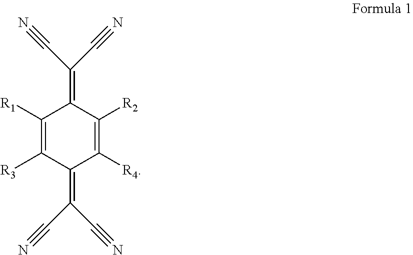

An electrolyte additive with a special structure is provided in this invention. The electrolyte additive is a polynitrile compound with a quinone-like structure. Furthermore, the invention provides the electrolyte additive with a special structure that is a stable conjugated olefin structure formed by a nitrile group and a quinone-like structure. Compared with the prior art, the compound undergoes an oxide-redox reaction to form a protective and stable solid state interface attached to the surface of the positive electrode and the negative electrode. The positive electrode interface film can alleviate the particle cracking and the catalytic oxidative decomposition of the electrolyte under high voltage, while the negative electrode interface film can inhibit the reduction and decomposition of the electrolyte at the negative electrode interface. More importantly, the solid electrolyte interface membrane has low impedance, and its lithium ion conductivity is much higher than that of conventional solid electrolyte interface membranes, which makes the lithium ion battery have excellent rate performance, low temperature performance and cycle performance. Therefore, the electrolyte additive of the present invention can improve battery cycle performance while taking into account both rate and low temperature performance.

Specifically, halogen atom is F, Cl, Br, or I atom. The substituted or unsubstituted chain C₁-C₁₂ alkyl group refers to a straight chain alkyl group or a branched alkyl group having 1 to 12 carbon atoms. The substituted or unsubstituted chain C₂-C₁₂ alkenyl group refers to a straight chain alkenyl group or a branched alkenyl group having 2 to 12 carbon atoms. The substituted or unsubstituted chain C₂-C₁₂ alkynyl group refers to a straight chain alkynyl group or a branched alkynyl group having 2 to 12 carbon atoms. RCₙH₂ₙ₊₁ refers to —O—CₙH₂ₙ₊₁ or —S—CₙH₂ₙ₊₁.

Preferably, R₁, R₂, R₃, and R₄ are each independently hydrogen atom, fluorine atom, a substituted or unsubstituted chain C₁-C₃alkyl group, or groups represented by RCₙH₂ₙ₊₁, R is each independently oxygen atom or sulfur atom, and n is positive integer less than 5.

Preferably, the compound represented by Formula 1 includes at least one of the compounds A to J:

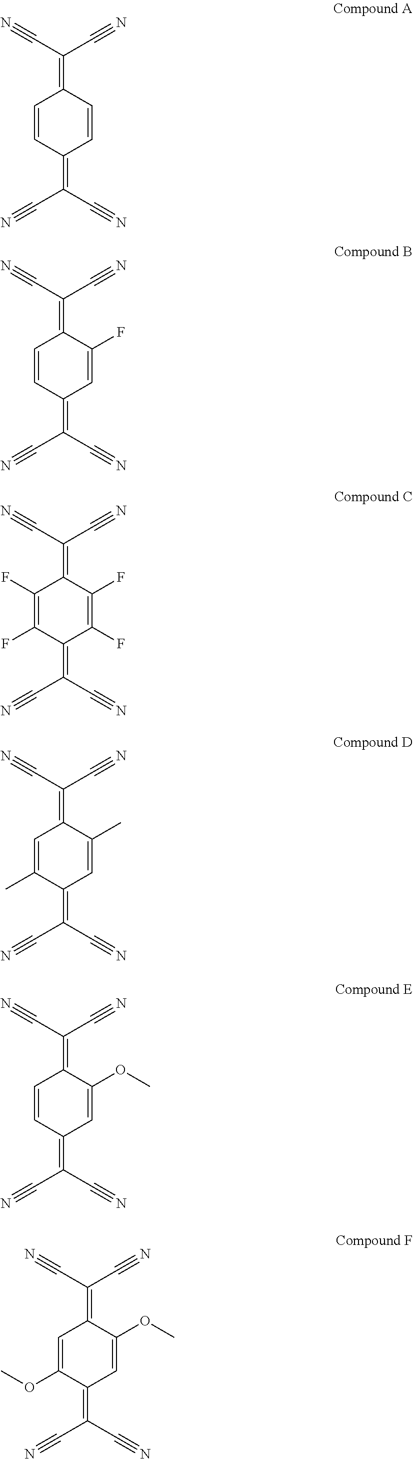

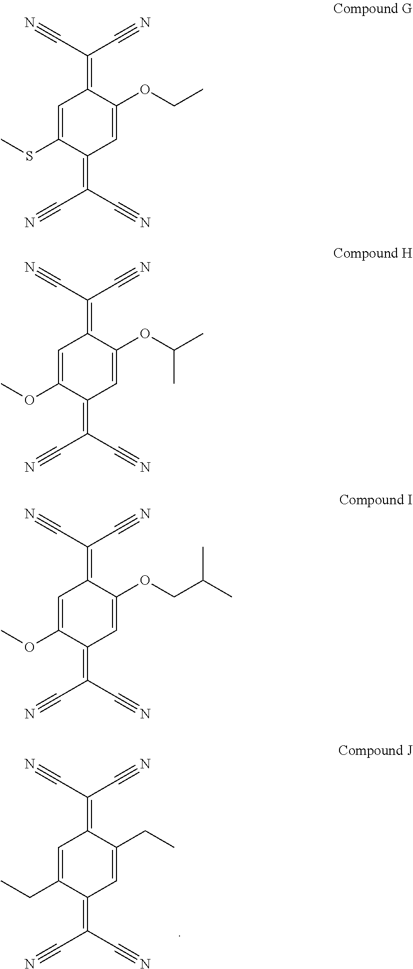

Specifically, the CAS Numbers of the compounds represented by compounds A-D are 1518-16-7, 69857-37-0, 29261-33-4, and 1487-82-7. Compounds E-J were synthesized by the method described in R. C. Wheland, E. L. Martin. J. Org. Chem., 1975, 40, 3101-3109.

The present invention also provides a non-aqueous electrolyte which includes a lithium salt, a non-aqueous organic solvent, and the above-mentioned electrolyte additive. Preferably, weight percentage of the compound represented by Formula 1 in the non-aqueous electrolyte is 0.1˜2%. For example, weight percentage of the compound represented by Formula 1 is 0.1%, 0.2%, 0.5%, 0.8%, 1.0%, 1.3%, 1.5%, 1.8%, or 2%, but not limited to it.

Preferably, the lithium salt is at least one selected from groups consisting of lithium hexafluorophosphate (LiPF₆), lithium difluorophosphate (LiPO₂F₂), lithium bis(oxalate)borate (LiBOB), lithium oxalyldifluoroborate (LiODFB), lithium difluoro bis(oxalato)phosphate (LiDFOP), lithium tetrafluoroborate (LiBF₄), lithium tetrafluoro(oxalato)phosphate (LiTFOP), lithium bistrifluoromethanesulfonimide (LiTFSI), lithium bis(fluorosulfonyl)imide (LiFSI), and lithium tetrafluoromalonate phosphate. The synthesis method of lithium tetrafluoromalonate phosphate is described in Chinese patent CN108822151B. Preferably, weight percentage of the lithium salt in the non-aqueous electrolyte is 10˜20%. For example, weight percentage of the lithium salt is 10%, 11%, 12%, 13%, 14%, 15%, 16%, 17%, 18%, 19%, or 20%, but not limited to it. The concentration of lithium salt in non-aqueous electrolyte is 0.5˜2.5 mol/L.

Specifically, the non-aqueous organic solvent is at least one selected from groups consisting of ethylene carbonate (EC), dimethyl carbonate (DMC), diethyl carbonate (DEC), ethyl methyl carbonate (EMC), propylene carbonate (PC), fluoroethylene carbonate (FEC), butyl acetate (n-BA), γ-butyrolactone (GBL), n-propyl propionate (n-PP), ethyl propionate (EP), and ethyl butyrate (EB). Preferably, the non-aqueous organic solvent is a mixture of dimethyl carbonate (DMC), diethyl carbonate (DEC), ethyl methyl carbonate (EMC), and fluoroethylene carbonate (FEC), and weight percentage of FEC in the non-aqueous organic solvent is 6 to 10%. By increasing FEC content in the electrolyte, cycle stability of the battery under high voltage can be improved, and furthermore there is a synergy effect between the compound represented by Formula 1 and FEC, which adjusts decomposition rate of FEC to form electronic insulation interface layer containing LiF. So it is beneficial to improve the cycle performance and high-low temperature performance of lithium ion batteries under high voltage. Non-aqueous organic solvent accounts for 60˜80% of the weight of non-aqueous electrolyte, which can be specifically 60%, 65%, 66%, 67%, 68%, 69%, 70%, 71%, 72%, 73%, 74%, 75%, or 80%, but not limited to it.

Preferably, the non-aqueous further includes a supplemental additive. The supplemental additive accounts for 2˜10.5% of the weight of the non-aqueous electrolyte, which can be specifically 2%, 3%, 4%, 5%, 6.5%, 7%, 8%, 9%, 10%, or 10.5%, but not limited to it. The supplemental additive is at least one selected from groups consisting of methyl trifluoroethyl carbonate (MTFEC), ethyl-2,2,2-trifluoroethyl carbonate (ETFEC), propyl-2,2,2-trifluoroethyl carbonate (PTFEC), vinylene carbonate (VC), diethyl pyrocarbonate (DEPC), 1,3-propane sultone (PS), dioxathiolane 2,2-dioxide (DTD), 1,2-difluoro-ethylene carbonate (DFEC), tris(trimethylsilyl)-phosphate (TMSP), tris(trimethylsilyl)-phosphite (TMSPi), [4,4′-Bi-1,3-dioxolane]-2,2′-dione (BDC), 3,3-Bi-1,3,2-Dioxathiolane 2,2-dioxide (BDTD), 4,4-Bi-1,3,2-Dioxathiolane 2,2-dioxide, triallyl phosphite (TAP), tripropargyl phosphate (TPP), succinonitrile (SN), adiponitrile (ADN), 1,3,6-hexanetricarbonitrile (HTCN), and ethylene glycol bis(propionitrile) ether (DENE). The supplemental additive can form a stable passivation film on the surface of the positive electrode. And the passivation film prevents the oxidative decomposition of the electrolyte on the surface of the positive electrode, inhibits dissolution of transition metal ions from the positive electrode, and improves the stability of the positive electrode material structure and positive electrode interface, thereby significantly improving the high temperature performance and cycle performance of the batteries.

Preferably, the supplemental additive is at least one selected from groups consisting of vinylene carbonate (VC), 1,3-propane sultone (PS), dioxathiolane 2,2-dioxide (DTD), tris(trimethylsilyl)-phosphate (TMSP), tris(trimethylsilyl)-phosphite (TMSPi), [4,4′-Bi-1,3-dioxolane]-2,2′-dione (BDC), 3,3-Bi-1,3,2-Dioxathiolane 2,2-dioxide (BDTD), and 4,4-Bi-1,3,2-Dioxathiolane 2,2-dioxide, and their contents are 0.1˜2%, 0.2˜6%, 0.2˜2%, 0.2˜2%, 0.1˜1.5%, 0.1˜1.5%, 0.1˜1.5%, 0.1˜1.5%, respectively. Dioxathiolane 2,2-dioxide (DTD) is added to the electrolyte to modify the components of SEI film on the negative electrode surface of the lithium battery and increases the relative content of sulfur and oxygen atoms. Sulfur atom and oxygen atom contain lone pair electrons, which can attract lithium ions, speed up the shuttle of lithium ions in the SEI film, and reduce interface impedance, thereby effectively improving the low-temperature charge and discharge performance of high-voltage lithium ion batteries, 1,3-Propane sultone (PS) has good film-forming properties. PS can form a large number of CEI films containing sulfonic acid groups at the positive electrode interface. The CEI films inhibit the decomposition of FEC at high temperature and increase the capacity loss of lithium ion batteries during the first charge and discharge, which helps to increase the reversible capacity of lithium ion batteries, thereby improving the high-temperature performance and long-term cycle performance of lithium ion batteries. Furthermore, tris(trimethylsilyl)-phosphate (TMSP) and tris(trimethylsilyl)-phosphite (TMSPi) can absorb water and free acid, thereby improving the cycle performance of the lithium ion batteries.

The present invention further provides a lithium ion battery including a positive electrode, a negative electrode, and above-mentioned non-aqueous electrolyte, and the maximum charging voltage is 4.5V. The electrolyte contains the compound represented by Formula 1 as an additive, which can improve the cycle performance, high-low temperature performance and rate performance of the battery. Among them, the positive electrode material is preferably lithium cobalt oxide, which can be pure LCO, doped and/or coated LCO. There is an adsorption coordination effect between the nitrile groups of the compound represented by Formula 1 and the cobalt ion. Due to the coordination effect, the lone pair electrons on the N2p orbital of the nitrile group reduces the actual oxidizability of Co^{3+/4+}, so that its catalytic effect on electrolyte is weakened.

### BRIEF DESCRIPTION OF THE DRAWINGS

The accompanying drawings facilitate an understanding of the various embodiments of this invention. In such drawings:

FIG. 1 shows an oxidation potential diagram of Example 1 and Comparative Example 1;

FIG. 2 shows a reduction potential diagram of Example 1 and Comparative Example 1;

FIG. 3 shows a positive electrode impedance diagram of Example 1 and Comparative Examples 1-3;

FIG. 4 shows a negative electrode impedance diagram of Example 1 and Comparative Examples 1-3; and

FIG. 5 shows dQ/dV-V curves of Example 1 and Comparative Example 1 under the formation stage.

### DETAILED DESCRIPTION OF ILLUSTRATED EMBODIMENTS

The present invention will be described with reference to the specific embodiments. The following description of the example(s) is illustrative in nature and is not intended to limit the disclosure, its application, or uses.

### Example 1

Electrolyte Preparation

All samples were prepared in a nitrogen atmosphere glovebox (<1 ppm of O₂ and H₂O) by mixing dimethyl carbonate, diethyl carbonate, and ethyl methyl carbonate in a mass ratio of 4:5:3 to obtain 79.7 g non-aqueous organic solvent, and 0.3 g compound A was added to the non-aqueous organic solvent to obtain a mixed solution. Then the mixed solution was sealed, placed and then frozen for 2h in the freezing chamber (−4° C.). Then, 20 g LiPF₆ was slowly added to the mixed solution with stirring until a homogeneous solution in a nitrogen atmosphere glovebox (<1 ppm of O₂ and H₂O) and the electrolyte was obtained.

The electrolyte formulations in Examples 2-20 and Comparative Examples 1-8 are shown in Table 1 below. The method of preparing the electrolyte is the same as that in Example 1.

TABLE 1

| | Non-aqueous organic | lithium salt/ | Additive/Mass | Supplemental |
|---|---|---|---|---|
| Examples | solvent/Mass (g) | Mass (g) | (g) | additive/Mass (g) |
| Ex.1 | DMC/DEC/EMC | LiPF₆/20 | Compound | |
| | (4:5:3)/79.7 | | A/0.3 | |
| Ex.2 | DMC/DEC/EMC | LiPF₆/20 | Compound | |
| | (4:5:3)/79.9 | | I/0.1 | |
| Ex.3 | DMC/DEC/EMC | LiPF₆/19.5 | Compound | |
| | (4:5:3)/79.7 | LiBF₄/0.5 | A/0.3 | |
| Ex.4 | EC/PC/EMC/DEC | LiPF₆/20 | Compound | |
| | (2:3:5:2)/79.7 | | A/0.3 | |
| Ex.5 | DMC/DEC/EMC | LiPF₆/20 | Compound | VC/0.3 |
| | (4:5:3)/79.4 | | A/0.3 | |
| Ex.6 | DMC/DEC/EMC | LiPF₆/20 | Compound | PS/0.3 |
| | (4:5:3)/79.4 | | A/0.3 | |
| Ex.7 | DMC/DEC/EMC | LiPF₆/20 | Compound | FEC/0.3 |
| | (4:5:3)/79.4 | | A/0.3 | |
| Ex.8 | DMC/DEC/EMC/FEC | LiPF₆/20 | Compound | |
| | (4:5:3:1)/79.7 | | A/0.3 | |
| Ex.9 | DMC/DEC/EMC/FEC | LiPF₆/20 | Compound | |
| | (4:5:3:1)/79.5 | | A/0.5 | |
| Ex.10 | DMC/DEC/EMC/FEC | LiPF₆/20 | Compound | |
| | (4:5:3:1)/78 | | A/2 | |
| Ex.11 | DMC/DEC/EMC/FEC | LiPF₆/20 | Compound | |
| | (4:5:3:1)/79.7 | | C/0.3 | |
| Ex.12 | DMC/DEC/EMC/FEC | LiPF₆/20 | Compound | |
| | (4:5:3:1)/79.7 | | D/0.3 | |
| Ex.13 | DMC/DEC/EMC/FEC | LiPF_{6/}20 | Compound | |
| | (4:5:3:1)/79.7 | | G/0.3 | |
| Ex.14 | DMC/DEC/EMC/FEC | LiPF₆/19.5 | Compound | |
| | (4:5:3:1)/79.7 | LiDFOP/0.5 | A/0.3 | |
| Ex.15 | DMC/DEC/EMC/FEC | LiPF₆/19.5 | Compound | |
| | (4:5:3:1)/79.7 | LiPO₂F₂/0.5 | A/0.3 | |
| Ex.16 | DMC/DEC/EMC/FEC | LiPF₆/19.5 | Compound | |
| | (4:5:3:1)/79.7 | LiBOB/0.5 | A/0.3 | |
| Ex.17 | DMC/DEC/EMC/FEC | LiPF₆/20 | Compound | VC/0.5 |
| | (4:5:3:1)/79.2 | | A/0.3 | |
| Ex.18 | DMC/DEC/EMC/FEC | LiPF₆/20 | Compound | DTD/0.5 |
| | (4:5:3:1)/79.2 | | A/0.3 | |
| Ex.19 | DMC/DEC/EMC/FEC | LiPF₆/20 | Compound | TMSP/0.5 |
| | (4:5:3:1)/79.2 | | A/0.3 | |
| Ex.20 | DMC/DEC/EMC/FEC | LiPF₆/20 | Compound | PS/0.5 |
| | (4:5:3:1)/79.2 | | A/0.3 | |
| Com.1 | DMC/DEC/EMC | LiPF₆/20 | | |
| | (4:5:3)/80 | | | |
| Com.2 | DMC/DEC/EMC | LiPF₆/20 | ADN/0.3 | |
| | (4:5:3)/79.7 | | | |
| Com.3 | DMC/DEC/EMC | LiPF₆/20 | Compound | |
| | (4:5:3)/79.7 | | K/0.3 | |
| Com.4 | DMC/DEC/EMC/FEC | LiPF₆/20 | | |
| | (4:5:3:1)/80 | | | |
| Com.5 | DMC/DEC/EMC/FEC | LiPF₆/20 | SN/0.3 | |
| | (4:5:3:1)/79.7 | | | |
| Com.6 | DMC/DEC/EMC/FEC | LiPF₆/20 | ADN/0.3 | |
| | (4:5:3:1)/79.7 | | | |
| Com.7 | DMC/DEC/EMC/FEC | LiPF₆/20 | HTCN/0.3 | |
| | (4:5:3:1)/79.7 | | | |
| Com.8 | DMC/DEC/EMC/FEC | LiPF₆/20 | Compound | |
| | (4:5:3:1)/79.7 | | K/0.3 | |

Compound K is represented by the following formula:

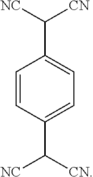 [SMILES: N#CC(C#N)c1ccc(C(C#N)C#N)cc1]

Lithium ion batteries were prepared by using lithium cobalt oxide with the highest charging voltage of 4.5V as the positive electrode material, and natural graphite as the negative electrode material. Lithium cobalt oxide was obtained from Tianjin B&M Science and Technology Co., Ltd. Lithium ion batteries were prepared using the electrolytes in Examples 1-20 and Comparative Examples 1-8 as reference to the conventional preparation method of lithium battery. The battery in each embodiment was tested for normal temperature cycle performance, high temperature cycle performance, low temperature discharge performance, high temperature storage performance, FEC remaining capacity test, and 3 C rate discharge performance. Further, the oxidation potential test, reduction potential test, positive electrode impedance test, and negative electrode impedance test were performed on Example 1 and Comparative Example 1. The dQ/dV-V curve of the formation stage was characterized. The test conditions are as follows, and the test results are shown in Table 2 and in the drawings.

Normal Temperature Cycle Performance Test

The lithium ion batteries were placed in a room (25° C.), charged to 4.5V at a constant current of IC, then charged at a constant voltage until the current reached 0.05 C, then discharged to 3.0V at a constant current of IC, and then that cycle was repeated 500 times. The discharge capacity of the first cycle and the discharge capacity of the last cycle were recorded. The capacity retention rate under normal temperature cycle was calculated by the following formula.

Capacity retention rate (%)=Discharge capacity of the last cycle/Discharge capacity of the first cycle×100%

High Temperature Cycle Performance Test

The lithium ion batteries were placed in a room (45° C.), charged to 4.5V at a constant current of 1 C, then charged at a constant voltage until the current reached 0.05 C, then discharged to 3.0V at a constant current of IC, and then that cycle was repeated 500 times. The discharge capacity of the first cycle and the discharge capacity of the last cycle were recorded. The capacity retention rate under high temperature cycle was calculated by the following formula.

Capacity retention rate (%)=Discharge capacity of the last cycle/Discharge capacity of the first cycle×100%

Low Temperature Discharge Performance Test

At room temperature, the lithium ion batteries were charged to 4.5V at a constant current of 0.5 C, and then charged at a constant voltage until the current reached 0.05 C. Then the lithium ion batteries were placed in a constant temperature box (−20° C.) and discharged at a constant current of 0.5 C to 3.0V voltage.

Capacity retention rate (%)=Retention capacity/Initial capacity×100%

High Temperature Storage Performance Test

The formatted batteries were charged to 4.5V at a constant current of IC and constant voltage at room temperature, and the initial capacity and the initial battery thickness were measured. Then the batteries were stored at 85° C. for 8 hours and then discharged to 3.0V at a constant current of IC to measure the retention capacity and the recovery capacity and battery thickness after storage. The results were calculated by the following formula.

Capacity retention rate (%)=Retention capacity/Initial capacity×100%

Capacity recovery rate (%)=Recovery capacity/Initial capacity×100%

Thickness expansion (%)=(Battery thickness after storage−Initial battery thickness)/Initial battery thickness×100%

FEC Remaining Capacity Test

The batteries after the 500 high temperature cycles were disassembled, the positive electrode, the negative electrode and the separator were soaked in dichloromethane for 24 hours, and then the extract liquor was taken out to detect the FEC content by GC.

3 C Rate Discharge Performance Test

At room temperature, the batteries were charged with a constant current of 0.5 C to 4.5V, then charged at a constant voltage until the current reached 0.05 C, and then discharged at a constant current of 3 C to 3.0V.

Capacity retention rate (%)=Retention capacity/Initial capacity×100%

Oxidation Potential Test

The electrolytes prepared in Example 1 and Comparative Example 1 were added in a three-electrode system in which the working electrode was a platinum electrode, the reference electrode and the counter electrode were lithium electrodes. Then the three electrodes were placed on the electrochemical workstation for linear sweep voltammetry, the scanning voltage was 3V-7V and the scanning speed was 1 mV/s. The results are shown in FIG. 1.

Reduction Potential Test

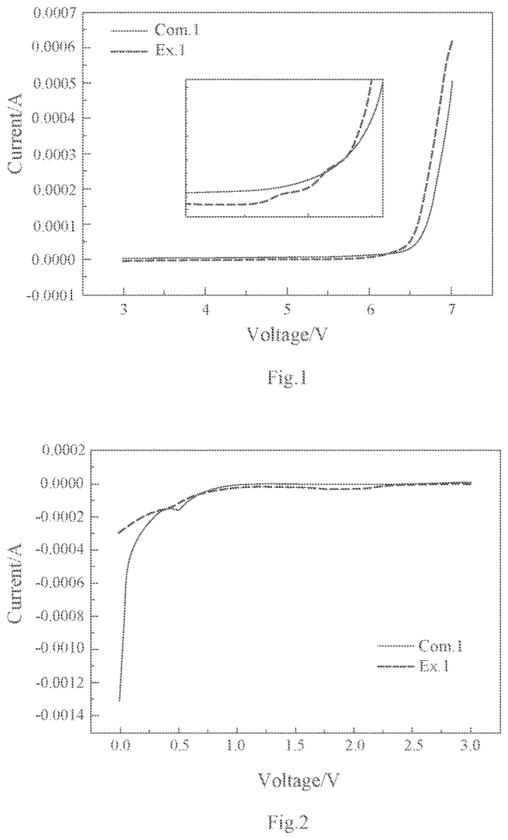

The electrolytes prepared in Example 1 and Comparative Example 1 were used to prepare lithium cobalt oxide|electrolyte|graphite button-type batteries. The button-type batteries were placed on the electrochemical workstation for linear sweep voltammetry, the scanning voltage was 3V-0V, and the scanning speed was 1 mV/s. The results are shown in FIG. 2.

Positive Electrode Impedance Test

The electrolytes prepared in Example 1 and Comparative Examples 1-3 were used to prepare lithium cobalt oxide|electrolyte|lithium plate button-type half batteries. And the button-type half batteries were placed on the electrochemical workstation for EIS test, and the results are shown in FIG. 3.

Negative Electrode Impedance Test

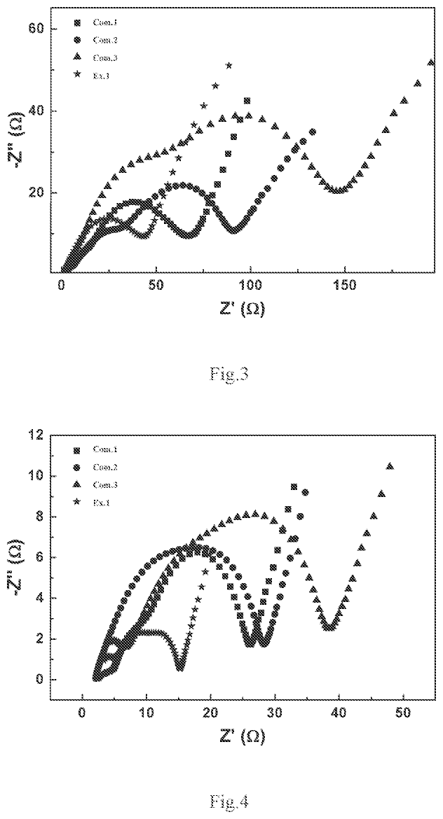

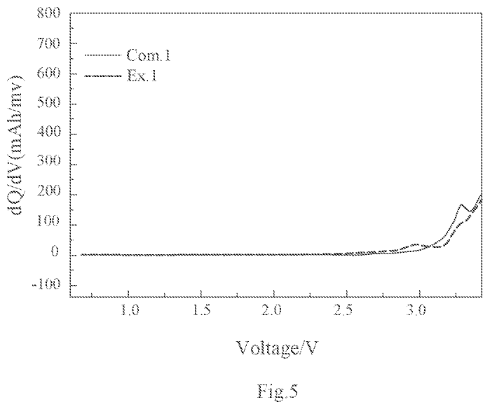

The electrolytes prepared in Example 1 and Comparative Examples 1-3 were used to prepare graphite|electrolyte|lithium plate button-type half batteries. And the button-type half batteries were placed on the electrochemical workstation for EIS test, and the results are shown in FIG. 4.

dQ/dHV-V Curve on the Formation Stage

The voltage and capacity information of the batteries on formation stage in Example 1 and Comparative Example were extracted to create a dQ)/dV-V curve. The results are shown in FIG. 5.

TABLE 2
Cycle performance and high-low temperature performance, FEC remaining
capacity test results after the 500 high temperature cycles

| | | | Low temperature | FEC remaining | | High temperature storage | | |
|---|---|---|---|---|---|---|---|---|
| | Capacity | | discharge | capacity after | | performance (85° C., 8 h) | | |
| | retention rate | | performance | 500 high | 3 C rate | Capacity | Capacity | |
| | after 500 cycles | | (−20° C., | temperature | discharge | retention | recovery | Thickness |
| Examples | 25° C. | 45° C. | 0.5 C) | cycles | performance | rate | rate | expansion |
| Ex. 1 | 74.2% | 63.9% | 72.8% | / | 77.4% | 84.2% | 88.2% | 3.5% |
| Ex. 2 | 75.1% | 64.2% | 72.3% | / | 76.3% | 83.5% | 87.9% | 2.9% |
| Ex. 3 | 73.8% | 65.1% | 71.4% | / | 75.1% | 85.3% | 89.7% | 2.0% |
| Ex. 4 | 75.6% | 64.7% | 72.1% | / | 77.8% | 83.5% | 88.8% | 3.7% |
| Ex. 5 | 78.4% | 69.2% | 71.5% | / | 77.6% | 87.5% | 89.8% | 0.9% |
| Ex. 6 | 77.4% | 73.5% | 72.3% | / | 81.2% | 88.9% | 91.3% | 0.7% |
| Ex. 7 | 80.6% | 72.1% | 73.9% | 0.2% | 81.3% | 88.2% | 91.4% | 1.0% |
| Ex. 8 | 88.9% | 85.4% | 76.7% | 4.8% | 85.9% | 92.1% | 95.4% | 0.2% |
| Ex. 9 | 88.2% | 86.7% | 76.4% | 4.9% | 86.1% | 93.5% | 95.0% | 0.3% |
| Ex. 10 | 87.8% | 88.1% | 74.3% | 5.1% | 85.4% | 93.1% | 94.9% | 0.2% |
| Ex. 11 | 89.5% | 87.4% | 77.9% | 4.7% | 87.1% | 94.2% | 96.6% | 0.2% |
| Ex. 12 | 89.3% | 88.0% | 78.1% | 4.8% | 88.3% | 93.5% | 96.7% | 0.1% |
| Ex. 13 | 88.9% | 88.1% | 78.6% | 5.0% | 87.1% | 93.4% | 96.5% | 0.3% |
| Ex. 14 | 90.2% | 89.5% | 81.4% | 4.9% | 89.5% | 93.7% | 96.1% | 0.2% |
| Ex. 15 | 90.1% | 89.5% | 81.2% | 4.8% | 89.7% | 94.3% | 95.9% | 0.2% |
| Ex. 16 | 90.3% | 88.7% | 80.2% | 4.9% | 89.0% | 94.4% | 96.1% | 0.1% |
| Ex. 17 | 90.1% | 89.5% | 74.6% | 4.8% | 86.9% | 93.5% | 95.4% | 0.2% |
| Ex. 18 | 89.6% | 86.9% | 80.1% | 4.7% | 87.8% | 92.9% | 94.7% | 0.4% |
| Ex. 19 | 90.2% | 85.8% | 81.6% | 5.2% | 88.4% | 93.5% | 96.7% | 0.1% |
| Ex. 20 | 92.1% | 90.9% | 81.0% | 5.4% | 89.3% | 95.2% | 97.2% | 0.1% |
| Com. 1 | 62.3% | <10% | 54.2% | / | 60.3% | 72.4% | 75.2% | 10.5% |
| Com. 2 | 65.9% | <10% | 50.3% | / | 57.6% | 79.5% | 83.7% | 8.4% |
| Com. 3 | 68.7% | <10% | 52.9% | / | 56.4% | 82.0% | 85.8% | 7.6% |
| Com. 4 | 78.3% | 73.4% | 71.5% | 1.3% | 78.3% | 75.1% | 80.9% | 7.9% |
| Com. 5 | 82.5% | 80.0% | 65.6% | 1.5% | 70.5% | 83.4% | 87.8% | 5.5% |
| Com. 6 | 81.9% | 81.6% | 66.8% | 1.4% | 71.2% | 84.3% | 88.7% | 4.4% |
| Com. 7 | 83.8% | 82.1% | 63.4% | 1.8% | 68.1% | 85.8% | 89.0% | 4.2% |
| Com. 8 | 84.1% | 80.9% | 67.5% | 2.0% | 72.3% | 84.9% | 90.1% | 3.9% |

The results in Table 2 show that compared to Comparative Examples 1-8, the normal temperature cycle performance, high temperature cycle performance, low temperature discharge performance, high temperature storage performance, and rate capability of Examples 1 to 20 are all at a better level. Because the electrolyte additive with a special structure is used in this invention, which is a stable conjugated olefin structure formed by a nitrile group and a quinone-like structure. Compared with the prior art, during the first charge and discharge process, the conjugated olefin structure formed by the nitrile group and the quinone-like structure undergoes a redox reaction to form a redox product attached to the surface of the positive electrode and the negative electrode to form a solid electrolyte interface film with a stable skeleton. The positive electrode interface film can alleviate the particle breakage of the positive electrode active material and the catalytic oxidative decomposition of the electrolyte under high voltage, and the negative electrode interface film can inhibit the reduction and decomposition of the electrolyte at the negative electrode interface. More importantly, the solid electrolyte interface membrane has low impedance, and its lithium ion conductivity is much higher than that of conventional solid electrolyte interface membranes, which makes the lithium ion battery have excellent rate performance, low temperature performance and cycle performance. Therefore, the electrolyte additive of the present invention can improve battery cycle performance while taking into account both rate and low temperature performance.

In Comparative Examples 2 and 5-7, although nitrile additives were added, which can improve the cycle performance to a certain extent, especially in Comparative Examples 4-7, the cycle performances are better under the action of FEC and nitrile additives. But low temperature performance and rate performance in Comparative Examples 2 and 5-7 are obviously inferior to the examples containing the compounds represented by Formula 1. Although compound K, whose structure is similar to the compound represented by Formula 1, was added in Comparative Example 3 and Comparative Example 8, compound K also does not have the conjugated olefin structure of the compound represented by Formula 1, and contains a benzene ring structure. So the compound K also fails to improve low temperature performance and rate performance.

From Example 1 and Examples 7-8, it can be seen that when both the compound represented by Formula 1 and a high content of FEC are contained, the cycle performance of the high voltage lithium cobalt oxide batteries are more significantly improved. This is because the compound represented by Formula 1 in the present invention can synergize with FEC to adjust the decomposition rate of FEC to form an electronic insulation interface layer containing LiF, which is beneficial to improve the cycle performance and high-low temperature performance of lithium ion batteries under high voltage. Furthermore, from the results of FEC remaining capacity after 500 high temperature cycles in Table 1, it can be seen that when both the compound represented by Formula 1 and high content of FEC are added, the detected FEC content is higher, indicating that the compound represented by Formula 1 inhibits the decomposition of FEC.

Comparing Example 8 with Examples 14-16, it can be seen that adding other lithium salt along with lithium hexafluorophosphate, the batteries have better cycle performance and high-low temperature performance.

From Examples 5-6 and Examples 17-20, it can be seen that the cycle performance and high temperature performance of the batteries with PS are better than those of the batteries with other additives, which is due to 1, 3-Propane sultone (PS) has good film-forming performance as a promoter. PS can form a large number of CEI films containing sulfonic acid groups at the positive electrode interface. The CEI films inhibit the decomposition of FEC at high temperature, and increase the capacity loss of lithium ion batteries during the first charge and discharge, which helps to increase the reversible capacity of lithium ion batteries, thereby improving the high-temperature performance and long-term cycle performance of lithium ion batteries.

It can be seen from the oxidation potential results in FIG. 1 that the electrolyte containing compound A in Example 1 is oxidized prior to the blank electrolyte in Comparative Example 1 at about 5.8 v. It can be seen from the reduction potential results in FIG. 2 that the electrolyte containing compound A in Example 1 takes part in the reduction reaction on the negative electrode prior to the blank electrolyte in Comparative Example 1 at about 2.0V, and the decomposition of the electrolyte is inhibited. It can be seen from the results of positive and negative electrode impedances in FIG. 3 and FIG. 4 that the positive and negative electrode impedances of the electrolyte containing compound A in Example 1 after formation are obviously smaller than those of the blank electrolyte in Comparative Example 1, the electrolyte containing ADN in Comparative Example 2, and the electrolyte containing compound K in Comparative Example 3. According to the dQ/dV-V curves under the formation stage in FIG. 5, compound A is preferentially taken part in the film formation at 3.0V, and the reaction of solvent in the film formation at 3.2V is inhibited.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. An electrolyte additive comprising a compound represented by Formula 1: 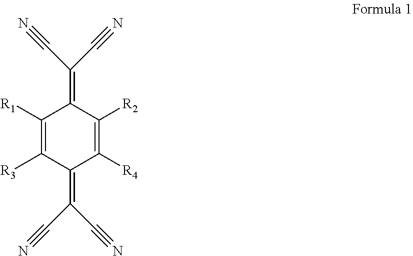
wherein, in Formula 1, R₁, R₂, R₃, and R₄ are each independently hydrogen atom, halogen atom, a substituted or unsubstituted chain C₁-C₁₂ alkyl group, a substituted or unsubstituted chain C₂-C₁₂ alkenyl group, a substituted or unsubstituted chain C₂-C₁₂ alkynyl group, or groups represented by RCₙH₂ₙ₊₁, R is each independently oxygen atom or sulfur atom, and n is positive integer.

2. The electrolyte additive according to claim 1, wherein R₁, R₂, R₃, and R₄ are each independently hydrogen atom, fluorine atom, a substituted or unsubstituted chain C₁-C₃alkyl group, or groups represented by RCₙH₂₊₁, R is each independently oxygen atom or sulfur atom, and n is positive integer less than 5.

3. The electrolyte additive according to claim 1, wherein the compound represented by Formula 1 comprises at least one of the compounds A to J below:

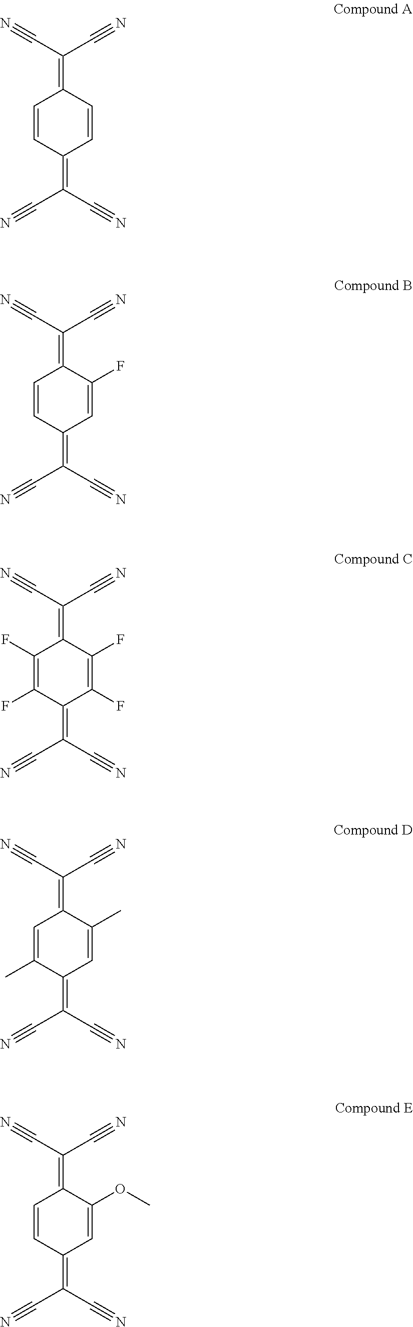 [SMILES: N#CC(C#N)=c1ccc(=C(C#N)C#N)cc1 ; N#CC(C#N)=c1ccc(=C(C#N)C#N)c(F)c1 ; N#CC(C#N)=c1c(F)c(F)c(=C(C#N)C#N)c(F)c1F ; Cc1cc(=C(C#N)C#N)c(C)cc1=C(C#N)C#N ; COc1cc(=C(C#N)C#N)ccc1=C(C#N)C#N]

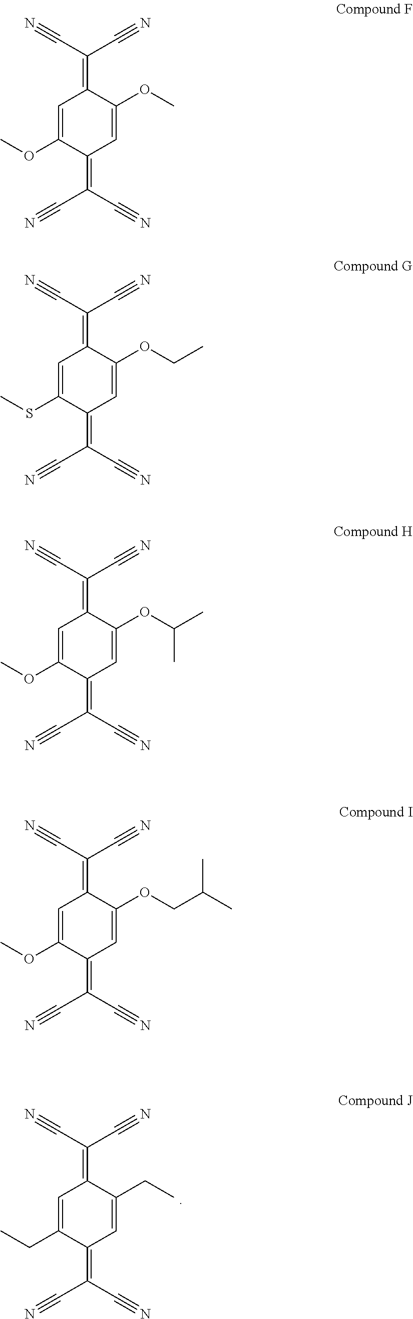

4. A non-aqueous electrolyte comprising a lithium salt, a non-aqueous organic solvent, and the electrolyte additive according to claim 1.

5. The non-aqueous electrolyte according to claim 4, wherein weight percentage of the compound represented by Formula 1 in the non-aqueous electrolyte is 0.1˜2%.

6. The non-aqueous electrolyte according to claim 4, wherein the lithium salt is at least one selected from groups consisting of lithium hexafluorophosphate, lithium difluorophosphate, lithium bis(oxalate)borate, lithium oxalyldifluoroborate, lithium difluoro bis(oxalato)phosphate, lithium tetrafluoroborate, lithium tetrafluoro(oxalato)phosphate, lithium bistrifluoromethanesulfonimide, lithium bis(fluorosulfonyl)imide, and lithium tetrafluoromalonate phosphate.

7. The non-aqueous electrolyte according to claim 4, wherein the non-aqueous organic solvent is at least one selected from groups consisting of ethylene carbonate, dimethyl carbonate, diethyl carbonate, ethyl methyl carbonate, propylene carbonate, fluoroethylene carbonate, butyl acetate, γ-butyrolactone, n-propyl propionate, ethyl propionate, and ethyl butyrate.

8. The non-aqueous electrolyte according to claim 4, further comprising a supplemental additive, wherein the supplemental additive is at least one selected from groups consisting of methyl trifluoroethyl carbonate, ethyl-2,2,2-trifluoroethyl carbonate, propyl-2,2,2-trifluoroethyl carbonate, vinylene carbonate, diethyl pyrocarbonate, 1,3-propane sultone, dioxathiolane 2,2-dioxide, 1,2-difluoro-ethylene carbonate, tris(trimethylsilyl)-phosphate, tris(trimethylsilyl)-phosphite, 4,4′-Bi-1,3-dioxolane]-2,2′-dione (BDC), 3,3-Bi-1,3,2-Dioxathiolane 2,2-dioxide (BDTD), 4,4-Bi-1,3,2-Dioxathiolane 2,2-dioxide, triallyl phosphite, tripropargyl phosphate, succinonitrile, adiponitrile, 1,3,6-hexanetricarbonitrile, and ethylene glycol bis(propionitrile) ether.

9. A lithium ion battery comprising a positive electrode, a negative electrode, and a non-aqueous electrolyte according to claim 4, and the maximum charging voltage being 4.5V.

10. The lithium ion battery according to claim 9, wherein the positive electrode is lithium cobalt oxide.
